(19) United States
(12) Patent Application Publication
(10) Pub. No.: US 2018/0160158 A1
(43) Pub. Date: Jun. 7, 2018

(54) METHOD AND SYSTEM FOR LIVE STREAM BROADCAST AND CONTENT MONETIZATION

(71) Applicants: Bing Liu, Rolling Hills, CA (US); Hongtao Yu, Rolling Hills, CA (US); Jianfeng Wu, Torrance, CA (US)

(72) Inventors: Bing Liu, Rolling Hills, CA (US); Hongtao Yu, Rolling Hills, CA (US); Jianfeng Wu, Torrance, CA (US)

(21) Appl. No.: 15/497,781

(22) Filed: Apr. 26, 2017

Related U.S. Application Data
(60) Provisional application No. 62/430,452, filed on Dec. 6, 2016.

(51) Int. Cl. H04N 21/2543; H04W 4/00; H04N 21/81

(52) U.S. Cl. CPC H04N 21/25435; H04N 21/812; H04W 4/003

(57) ABSTRACT

A mobile video-messaging platform allows an entity to perform a live broadcast of audio, video and/or text content. The mobile video-messaging platform may undergo branding and be released from a single business entity. Advertisement display is optimized based on placement strategy to ensure maximum revenue without compromising overall user experience. Virtual gifts are awarded to users viewing broadcast content. Premium live broadcasts require prospective viewers to pay in-app credit to view live broadcast content. Multiple virtual payment systems within the platform are provided. Using location-based features, viewers may pinpoint where nearby users and broadcasters are located. Gamification of the video-messaging platform encourages user involvement with the application.

### PRIORITY

This application claims priority to U.S. Provisional 62/413,392, filed Oct. 26, 2016, U.S. Provisional 62/430,452, filed Dec. 6, 2016, U.S. Provisional 62/430,472, filed Dec. 6, 2016, and U.S. Provisional 62/430,434, filed Dec. 6, 2016, each of which are hereby incorporated by reference as if submitted in their entireties.

### TECHNICAL FIELD

The present invention relates to live video streaming, and, more particularly, a method and system for monetizing content during a live media stream event on a mobile video messaging platform.

### BACKGROUND

In the new era of App Economy 2.0, software applications, or “Apps,” are quickly replacing websites as the face of businesses. The days when a few big entities dominated the Apps market will soon be gone. In the new App Economy, the market is expected to be run by many different kinds of branding Apps. Typical Apps require the employment of a developer or team of developers to create or produce a single App.

### BRIEF DESCRIPTION OF THE DRAWINGS

This disclosure is illustrated by way of example and not by way of limitation in the accompanying Fig(s). The Fig(s) may, alone or in combination, illustrate one or more embodiments of the disclosure. Elements illustrated in the Fig(s). are not necessarily drawn to scale. Reference labels may be repeated among the Figs. to indicate corresponding or analogous elements.

The detailed description makes reference to the accompanying Figs. in which:

FIG. 1 illustrates an aspect of an exemplary computing environment of the present invention;

FIG. 2 illustrates another aspect of an exemplary computing environment of the present invention;

FIG. 3 is an overview diagram of the present invention;

FIG. 4 is an exemplary application branding operation in accordance with at least one embodiment of the present invention;

FIG. 5 is a series of illustrated screenshots of optimal advertisement placement in accordance with the present invention;

FIG. 6 is an exemplary gamification scenario of the mobile video-messaging platform in accordance with at least one embodiment of the invention.

FIG. 7 is an exemplary pay-per-view content monetization method in accordance with the present invention.

FIG. 8 is an exemplary virtual gifting scenario method in accordance with the present invention;

FIG. 9 is an exemplary location-based content monetization method in accordance with the present invention;

FIG. 10 is an overview direct pay system in accordance with at least one embodiment of the present invention;

FIGS. 11A-11D are exemplary screenshots of at least one embodiment of the present invention;

FIGS. 12A-12D are exemplary screenshots of at least one embodiment of the present invention;

FIG. 13 is an exemplary screenshot of at least one embodiment of the present invention;

FIG. 14 is an exemplary screenshot of at least one embodiment of the present invention; and

FIG. 15 is an illustration of at least one embodiment of the present invention.

### DETAILED DESCRIPTION

The Figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

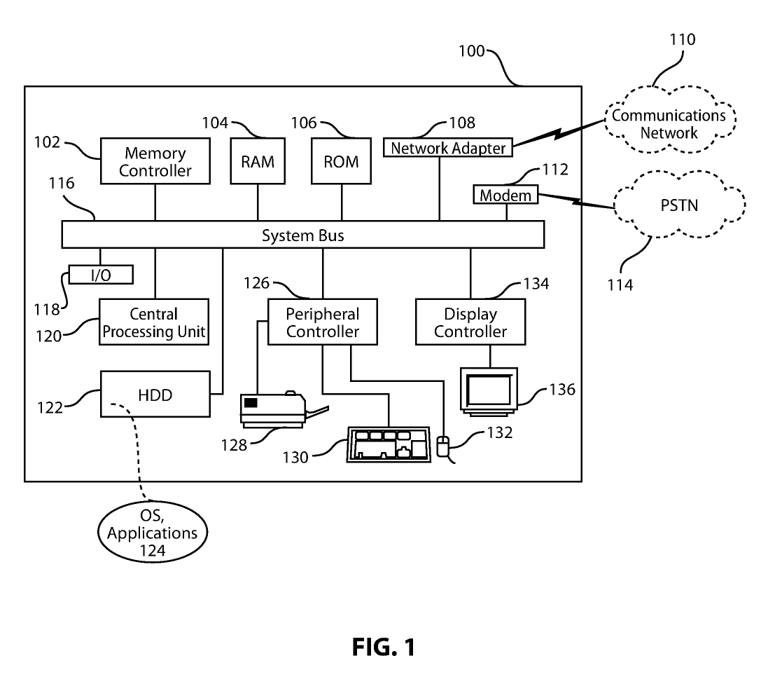

FIG. 1 illustrates an exemplary embodiment of a computer processing system 100 that may receive the various inputs as discussed herein, such as from local or remote sensors or GUIs, and that may perform the processing and logic discussed throughout. That is, the exemplary computing system 100 may be used in accordance with herein described systems and methods.

Computing system 100 is capable of executing software, such as an operating system (OS) and one or more computing applications 124. The software may likewise be suitable for operating hardware, such as via inputs/outputs (I/O), using said applications 124.

The operation of exemplary computing system 100 is controlled primarily by computer readable instructions, such as instructions stored in a computer readable storage medium, such as a hard disk drive (HDD) 122, an optical disk (not shown) such as a CD or DVD, a solid state drive (not shown) such as a USB “thumb drive,” or the like. Such instructions may be executed within central processing unit (CPU) 120 to cause computing system 100 to perform the disclosed operations. In many known computer servers, workstations, PLCs, personal computers, mobile devices, and the like, CPU 120 is implemented in an integrated circuit called a processor.

The various illustrative logics, logical blocks, modules, and engines, described in connection with the embodiments disclosed herein may be implemented or performed with any of a general purpose CPU, a digital signal processor (DSP), an application specific integrated circuit (ASIC), a field programmable gate array (FPGA) or other programmable logic device, discrete gate or transistor logic, discrete hardware components, or any combination thereof, respectively acting as CPU 120. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is appreciated that, although exemplary computing system 100 is shown to comprise a single CPU 124, such description is merely illustrative, as computing system 100 may comprise a plurality of CPUs 124. Additionally, computing system 100 may exploit the resources of remote or parallel CPUs (not shown), for example, through local or remote communications network 110 or some other data communications means.

In operation, CPU 124 fetches, decodes, and executes instructions from a computer readable storage medium, such as HDD 122. Such instructions can be included in the software, such as the operating system (OS), executable programs/applications, and the like. Information, such as computer instructions and other computer readable data, is transferred between components of computing system 100 via the system's main data-transfer path. The main data-transfer path may use a system bus architecture 116, although other computer architectures (not shown) can be used, such as architectures using serializers and deserializers and crossbar switches to communicate data between devices over serial communication paths.

System bus 116 may include data lines for sending data, address lines for sending addresses, and control lines for sending interrupts and for operating the system bus. Some busses provide bus arbitration that regulates access to the bus by extension cards, controllers, and CPU 124. Devices that attach to the busses and arbitrate access to the bus are called bus masters. Bus master support also allows multiprocessor configurations of the busses to be created by the addition of bus master adapters containing processors and support chips.

Memory devices coupled to system bus 116 can include random access memory (RAM) 104 and read only memory (ROM) 106. Such memories include circuitry that allows information to be stored and retrieved. ROMs 106 generally contain stored data that cannot be modified. Data stored in RAM 104 can generally be read or changed by CPU 124 or other communicative hardware devices. Access to RAM 104 and/or ROM 106 may be controlled by memory controller 102. Memory controller 102 may provide an address translation function that translates virtual addresses into physical addresses as instructions are executed. Memory controller 102 may also provide a memory protection function that isolates processes within the system and that isolates system processes from user processes. Thus, a program running in user mode can normally access only memory mapped by its own process virtual address space; it cannot access memory within another process' virtual address space unless memory sharing between the processes has been set up.

The steps and/or actions described in connection with the aspects disclosed herein may be embodied directly in hardware, in a software module executed by a processor locally or remotely, or in a combination of the two, in communication with memory controller 102 in order to gain the requisite performance instructions. That is, the described software modules to perform the functions and provide the directions discussed herein throughout may reside in RAM memory, flash memory, ROM memory, EPROM memory, EEPROM memory, registers, a hard disk, a removable disk, a CD-ROM, or any other form of storage medium known in the art. Any one or more of these exemplary storage medium may be coupled to the processor 124, such that the processor can read information from, and write information to, that storage medium. In the alternative, the storage medium may be integral to the processor. Further, in some aspects, the processor and the storage medium may reside in an ASIC. Additionally, in some aspects, the steps and/or actions may reside as one or any combination or set of instructions on an external machine readable medium and/or computer readable medium as may be integrated through I/O port(s) 118, such as a “flash” drive.

In addition, computing system 100 may contain peripheral controller 126 responsible for communicating instructions using a peripheral bus from CPU 124 to peripherals and other hardware, such as printer 128, keyboard 130, and mouse 132. An example of a peripheral bus is the Peripheral Component Interconnect (PCI) bus.

One or more hardware input/output (I/O) devices may be in communication with hardware controller 118. This hardware communication and control may be implemented in a variety of ways and may include one or more computer busses and/or bridges and/or routers. The I/O devices controlled may include any type of port-based hardware (and may additionally comprise software, firmware, or the like), such as the disclosed sensors and equipment inputs/outputs, and can also include network adapters and/or mass storage devices from which the computer system 100 can send and receive data for the purposes disclosed herein. The computer system 100 may thus be in communication with the Internet or other networked devices via the I/O devices and/or via communications network 110.

Display 136, which is controlled by display controller 134, may optionally be used to display visual output generated by computing system 100. Display controller 134 may also control, or otherwise be communicative with, the display. Visual output may include text, graphics, animated graphics, and/or video, for example. Display 136 may be implemented with a CRT-based video display, an LCD-based display, gas plasma-based display, touch-panel, or the like. Display controller 134 includes electronic components required to generate a video signal that is sent for display.

Further, computing system 100 may contain network adapter 108 which may be used to couple computing system 100 to an external communication network 110, which may include or provide access to the Internet, and hence which may provide or include tracking of and access to the process data discussed herein. Communications network 110 may provide user access to computing system 100 with means of communicating and transferring software and information electronically, and may be coupled directly to computing system 100, or indirectly to computing system 100, such as via PSTN or cellular network 114. For example, users may communicate with computing system 100 using communication means such as email, direct data connection, virtual private network (VPN), or other online communication services, or the like. Additionally, communications network 110 may provide for distributed processing, which involves several computers and the sharing of workloads or cooperative efforts in performing a task. It is appreciated that the network connections shown are exemplary and other means of establishing communications links between multiple computing systems 100, and/or with remote users, may be used.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

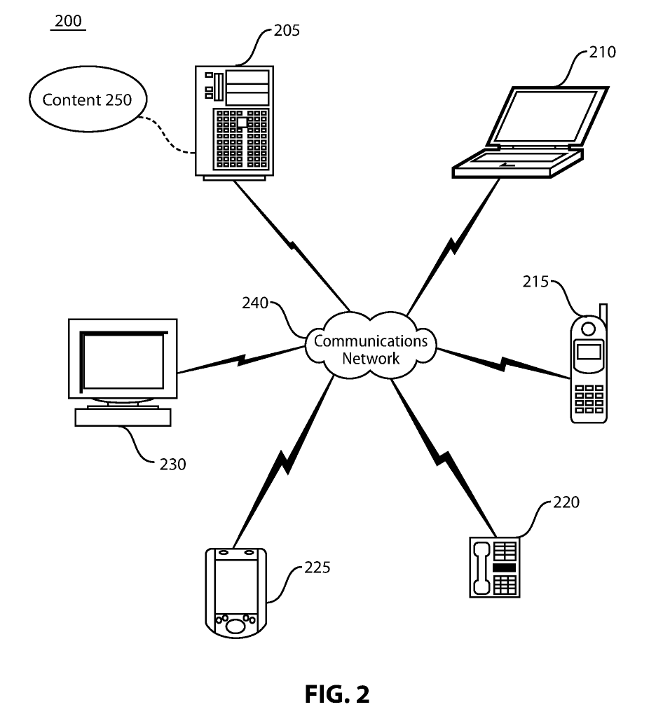

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

The present invention is and includes a branding application platform provider for the automated generation, configuration, and deployment of one or more software applications for individual entities. Individual entities may include, but are not limited to, individual businesses, consumers, politicians, contest organizers, and the like. The platform provides a software application, or app, that includes, but is not limited to, interactive live streaming, real-time location tracking, instant messaging and chat features, and/or content monetization.

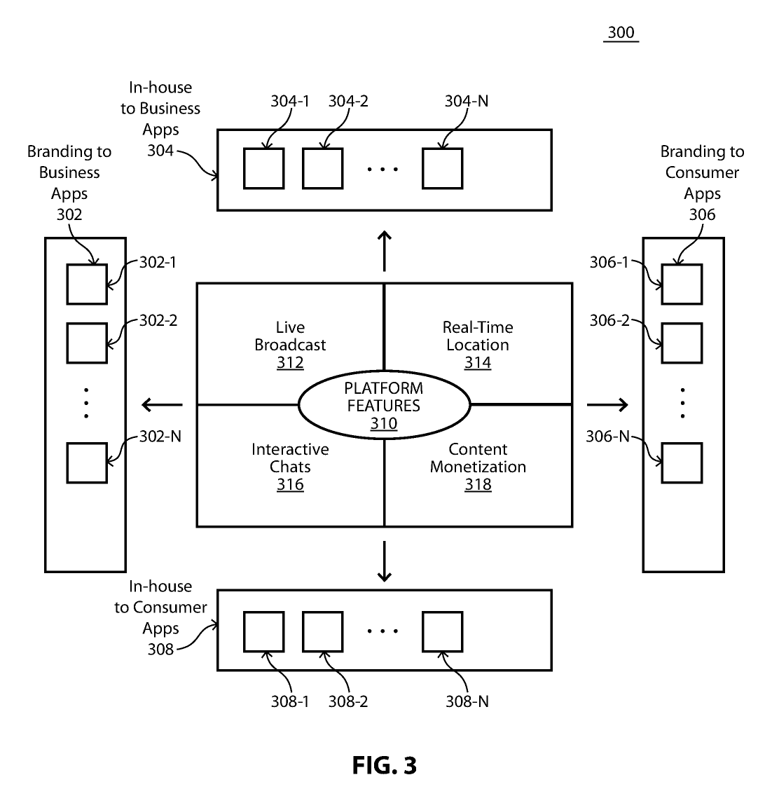

FIG. 3 is an overview diagram 300 of the branding application platform provider. The branding application platform may be used to create a plurality of different types of applications of different categories, based on needs and wants defined by an operating entity. For example, applications may be categorized as Branding-to-Business applications 302 (Apps 302-1, 302-2, . . . 302-N), In-house-to-Business applications 304 (Apps 304-1, 304-2, . . . 304-N), Branding-to-Consumer applications 306 (Apps 306-1, 306-2, . . . 306-N), and/or In-house-to-Consumer applications 308 (Apps 308-1, 308-2, . . . 308-N). Each application may be created and configured to comprise one or more Platform Features 310 which serve as main modules. Each application may therefore include, but is not limited to, Live Broadcast 312, Real-Time Location 314, Interactive Chats 316, and Content Monetization 318. Platforms may be deployed through this established platform, applications may be generated, configured, and deployed in high volume, quickly, with high quality, and with optimal efficiency.

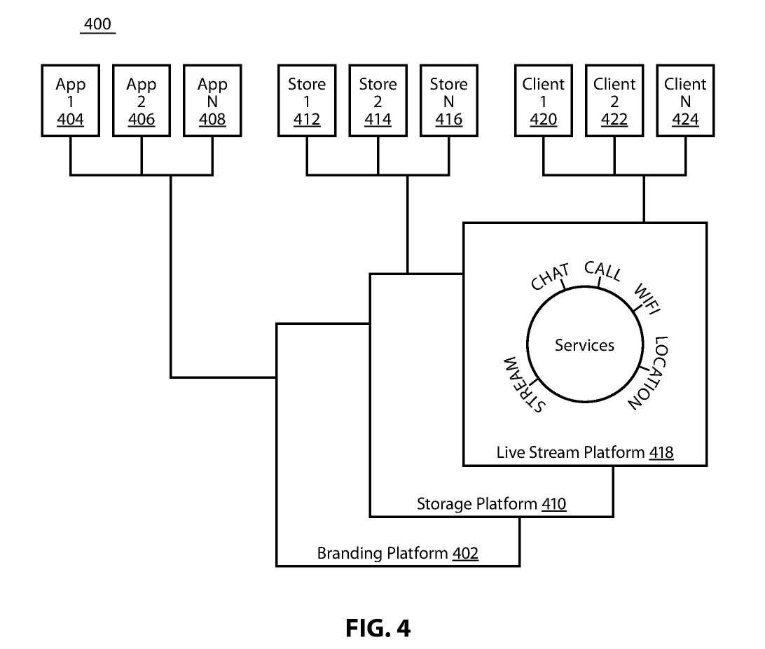

As shown in FIG. 4, an exemplary operation diagram 400 is shown with respect to cross-platform, or multilayered, communication. In operation, the system may include architecture comprising three platforms: Branding Platform 402, Storage Platform 410, and Live Stream Platform 418. Branding Platform, on the backend, may provide for the creation of a series of software applications (App-1 404, App-2 406, . . . App-N 408). Storage Platform 410 provides secure storage support at one or more remote or cloud storage locations (Store-1 412, Store-2 414, . . . Store-N 416). An exemplary cloud storage solution such as LiveBox® or cloud storage via Amazon® Web Services. In other embodiments, local storage may be used, such as on a mobile device's local memory, or a combination of local memory, such as a cache, and remote storage. Elimination of local device storage enables unlimited duration of a live stream event. Live stream broadcasts may be recorded and stored on the cloud storage and made available for later viewing. Live Stream Platform 418 provides services for user-facing front-end applications (client-1 420, client-2 422, . . . client-N 424). Services may include, but is not limited to, Chat, Call, wireless networking (e.g., WiFi®), location, and stream (e.g., audio/video) services. Each platform may be configured to run different applications and may also be deployed amongst different regions, such as in China or in the United States.

Live Stream Platform 418 provides an application for mobile device users on a global scale. Mobile device users may watch live stream broadcasts made by other users or may start their own personal live broadcast. For the duration of the broadcast, the broadcasting user and/or viewers of the broadcast may make comments (e.g., text, audio, video) which may be overlaid the broadcasted video during the stream or displayed within close proximity of the broadcast, such as directly above, below, or the like. During playback of a live broadcast, original comments made by viewing users and the broadcasting user may be shown as originally displayed during the original live broadcast. During playback of a broadcast replay, users may also leave additional comments, such as text, audio, or video comments.

The mobile video messaging platform supports either private or public broadcasting via the application, as determined by the broadcasting user. A user may set up a personal channel that other users may subscribe to, as well as options to share and/or forward private broadcasts. The broadcasting user may also decide to subscribe to and therefore follow and view other broadcasting users within the application. Based on predetermined security settings or personal options, interactive chats during the live stream may be one-to-one, between closed groups, or an open chat room. A broadcasting user may also have a personal channel having a personal memo, such as a personal diary or journal visible only to the broadcasting user. Utilizing the cloud storage, the user's personal memo is accessible virtually anywhere a network connection is attainable. The user's personal memo may be a cloud-based personal mobile audio and video recorder allowing the recording of audio/video/text notes and may also include location information (i.e. based off of GPS coordinates) and/or timestamp information. Using location-based information, the live stream broadcast application may also provide real-time location data of other users. Based on this real-time location data, subscribed users may locate friends and/or family and may receive notifications when others enter/leave certain areas of interest. For example, a parent may be notified when a child leaves school or when the child arrives home.

During a live broadcast on the mobile video messaging platform, a user may enable an AMA (“ask me anything”) broadcast session. During the session, viewing users may pose questions via audio/video/text comments to the broadcasting user. In another embodiment, viewing users may pay a small fee (e.g., 5 cents, $1) or redeem in-app credit before asking a question. Privacy settings may be set by the broadcasting user, such as to hide questions posed by viewers from all viewers, or the like.

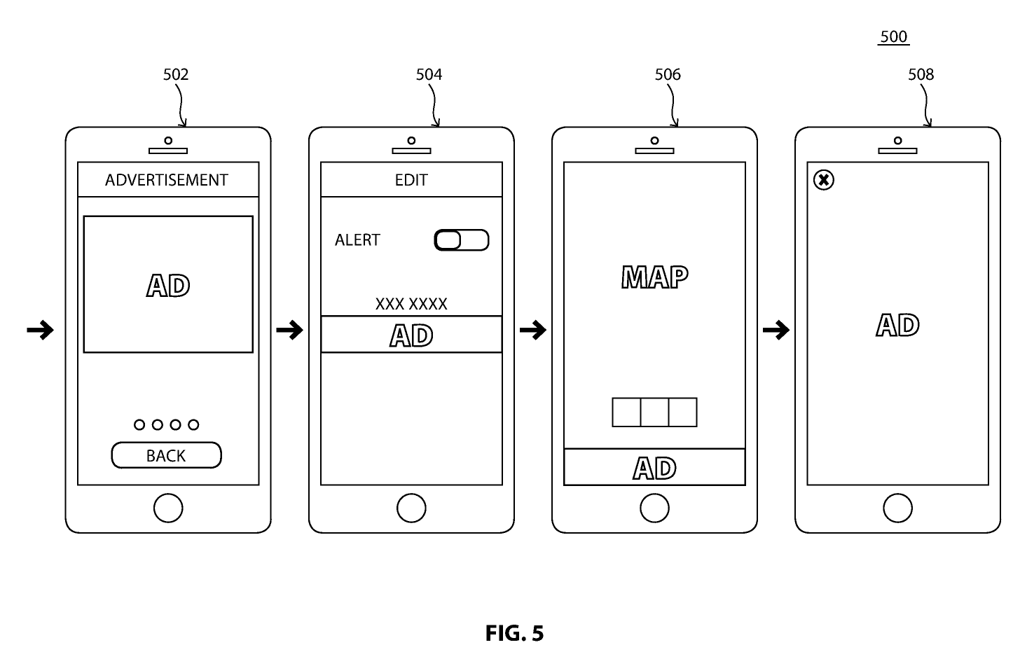

As is shown in FIG. 5, diagram 500 is a series of illustrated screenshots of optimal advertisement placement in accordance with the present invention. Optimal advertisement placement ensures and promotes maximum revenue without compromising the overall user experience. The overall user experience may even be improved based upon the insertion and display of relevant advertisements to users based on user-specific data, such as shopping habits or viewing habits. FIG. 5 shows exemplary ad placement configurations to complement the mobile video messaging application. As shown on the display of device 502, during an audio broadcast, an advertisement may be shown in a prominent location. The ad may take up a good portion of the screen, in this instance about 0.25 (¼) the screen size. While display real estate is a high commodity, it is considered less so during an audio event broadcast. In example 504, a smaller advertisement may be shown in the event a user of the device is performing settings operations. In example 506, a small advertisement may be displayed while a user is performing a full-screen operation with the app, in this instance a user is performing map operations. In example 508, a full-screen advertisement may be inserted during a playback of a video and displayed at key points during the video. Key points may be, but are not limited to, prior to playback, during an intermission, or at the conclusion of playback. In another embodiment, a full-screen ad may be displayed at the conclusion of a live audio/video broadcast stream. All types of advertisements may contain a hyperlink to a place on the web, generally associated with what the advertisements pertain to. The hyperlinks may be activated by simply being clicked or tapped on by a user input device (e.g., stylus, mouse cursor). In another embodiment, advertisers may insert third-party links that give a viewer an opportunity to view an advertisement.

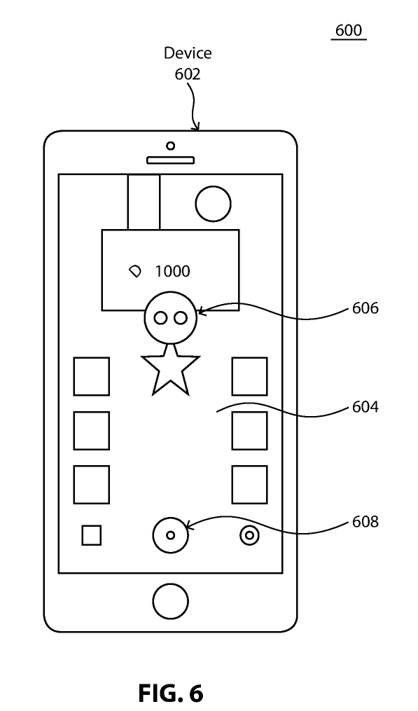

In another embodiment of the present invention, the video messaging platform may provide a location-based game mode where users may be encouraged to visit certain locations (e.g., businesses, landmarks). For example, in view of FIG. 6, scenario 600, a user, via their device 602, may view a certain location or broadcast 604 on their display. Based on this location, the application may cause an item 606 to display for “catching” by the user. Using the device 602, the user may aim and catch item 606 by dragging indicator 608 on the display towards item 606. Once caught, the user may be awarded points or in-app credit. The gamification of the video messaging application allows points or credit to be collected and later redeemed for in-app purchases. For example, the user may redeem points for access or usage of premium features of the application (e.g., redeem credit to view a pay-per-video video broadcast).

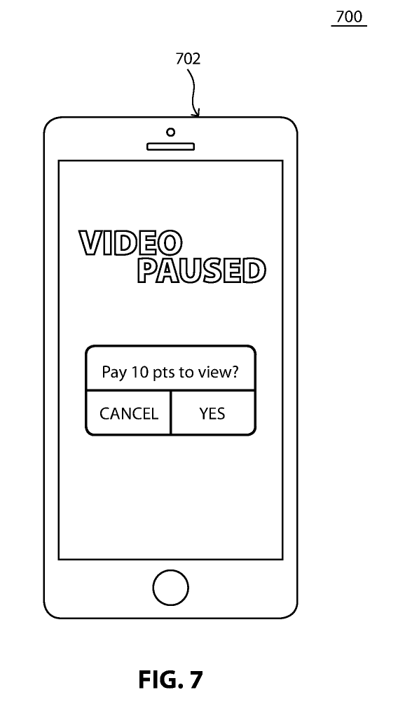

In accordance with FIG. 7, example 700 is an exemplary method for enabling pay-per-view of a live broadcast event. A broadcasting user may set or assign a monetary value or points value that a viewer is required to pay or redeem in order to view an event. Once a user selects the event, the user may be shown the screen on device 702 that requires payment before viewing. In example embodiments, a user may use in-app credit, points, or tokens. In another embodiment, a user may use a credit card or a mobile payment system (e.g., Google Wallet® or Apple Pay®).

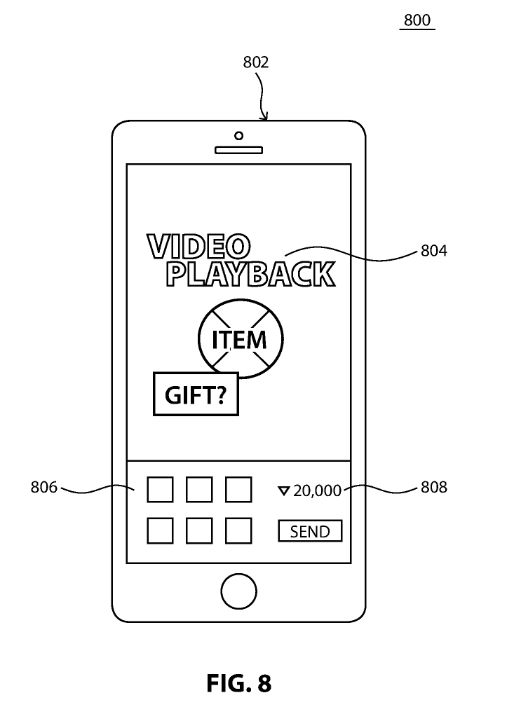

In accordance with FIG. 8, example 800, during video playback or during a broadcast event, a viewer may reward a broadcast host with virtual gifts. As shown on the exemplary screen of device 802, during video playback 804 a viewer may select from one or more virtual gifts 806 to bestow upon the broadcast host. The virtual gifts may be redeemed using in-app currency, such as diamonds 808. In another embodiment, a user may use a credit card or a mobile payment system (e.g., Google Wallet® or Apple Pay®) to purchase one or more virtual gifts. A user may purchase in-app credit (or diamonds) within the application using, for example, a credit card or mobile payment system as described above.

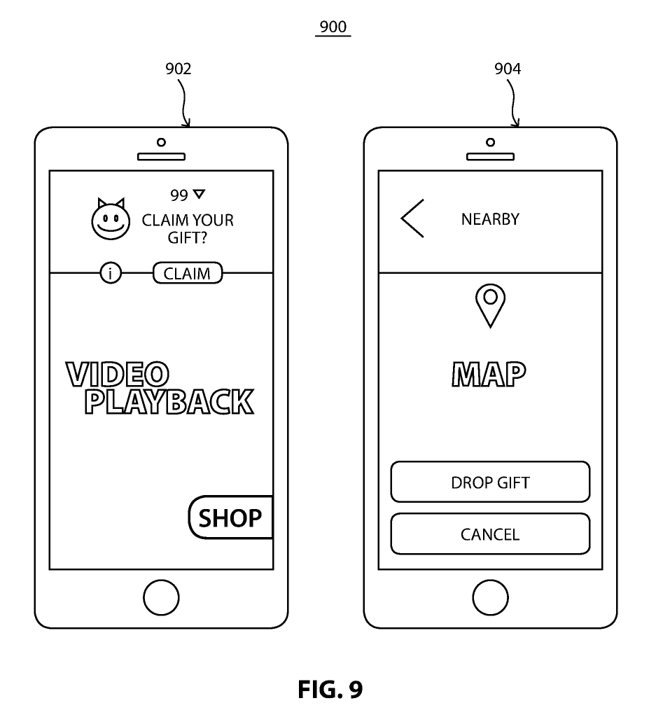

In accordance with FIG. 9, example 900, content monetization using location-based gift awarding is shown. Location-based gifting promotes business to customer interaction. For example, a business may send a virtual gift to reward viewers for viewing a broadcast's contents. A broadcasting user, such as one that represents a business, may enable a gift drop via a channel or setting within the app. Gifts may be set to become available at random, at certain points during a broadcast (e.g., before, during, after) and may also be location-based (e.g., when a user is within a certain distance or proximity of the business location). As shown on the display of device 902, during a video playback, a drop down menu may overlay the video showing the virtual gift, gift value, and who the gift is from, such as from a certain business. The gift provided may be random or pre-selected by the user representing the business. To add the virtual gift to their account, a viewer may simply click or tap on “CLAIM” and may redeem points, credit, or tokens via an in-app virtual store by clicking or tapping on “SHOP.” In one embodiment, as shown on the illustrated display of device 904, users may drop a virtual gift at certain locations on a map. Location may be determined based on certain cross-street location, address, by GPS coordinates, a certain pre-defined area or perimeter, or the like. Dropped virtual gifts may be assigned a certain time limit and therefore must be picked up within a specific time frame by viewing users or users of the app. One or more viewers may be given the chance to pick up or be rewarded the gift based on their location or by watching a live broadcast generated by a business within the location of the dropped gift. The dropped gift may be of a certain theme based on a certain event put on by the business.

As set forth above, the mobile video messaging platform supports either private or public broadcasting via the application, as determined by the broadcasting user. A user may set up a personal channel that other users may subscribe to, as well as options to share and/or forward private broadcasts. The broadcasting user may also decide to subscribe to and therefore follow and view other broadcasting users within the application. Based on predetermined security settings or personal options, interactive chats during the live stream may be one-to-one, between closed groups, or an open chat room. A broadcasting user may also have a personal channel having a personal memo, such as a personal diary or journal visible only to the broadcasting user. Utilizing the cloud storage, the user's personal memo is accessible virtually anywhere a network connection is attainable. The user's personal memo may be a cloud-based personal mobile audio and video recorder allowing the recording of audio/video/text notes and may also include location information (i.e. based off of GPS coordinates) and/or timestamp information. Using location-based information, the live stream broadcast application may also provide real-time location data of other users. Based on this real-time location data, subscribed users may locate friends and/or family and may receive notifications when others enter/leave certain areas of interest. For example, a parent may be notified when a child leaves school or when the child arrives home.

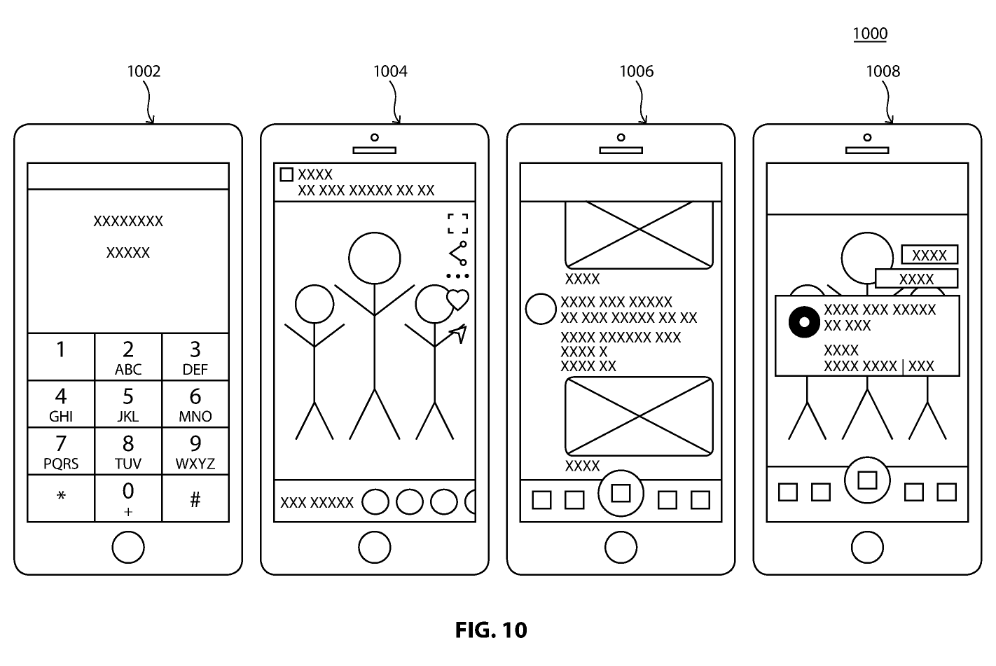

Referring to FIG. 10, the mobile video messaging platform may provide a plurality of different types of exemplary virtual payment systems 1000, such as during, before, or at the conclusion of a video broadcast. Payments may also be made at different points in time within the app platform. For example, payments may be made via credit card or via online money transfers (e.g., PayPal®, Venmo®, or WeChat Pay™). In a first embodiment, a flexible payment option is shown in exemplary screenshot 1002. During a live broadcast a viewer may choose to pay, or donate, an amount determined by the viewer. In a second embodiment, a fixed payment option is shown in exemplary screenshot 1004. During a live broadcast a viewer may choose to pay, or donate, an amount set by the broadcast host. In a third embodiment, a question-and-answer option is shown in exemplary screenshot 1006. A user may prepay a certain amount to a broadcast host as set by the host to answer a specific question posed by the viewer. In the event an insufficient answer is provided by the broadcast host, the payment made by the viewer may be refunded. In a fourth embodiment, a group payment option is shown in exemplary screenshot 1008. A group payment option enables a broadcast host to set a price amount per viewer and a minimum number of paying viewers before a live broadcast is initiated.

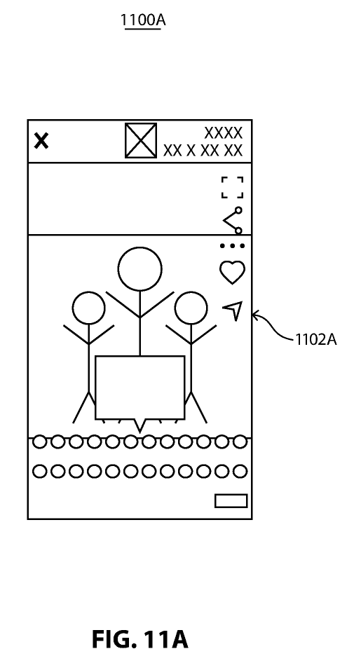

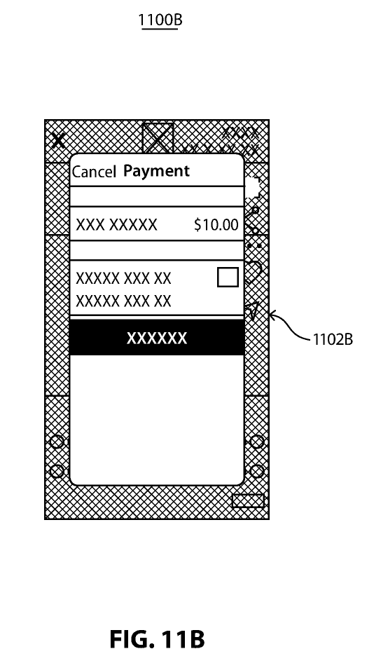

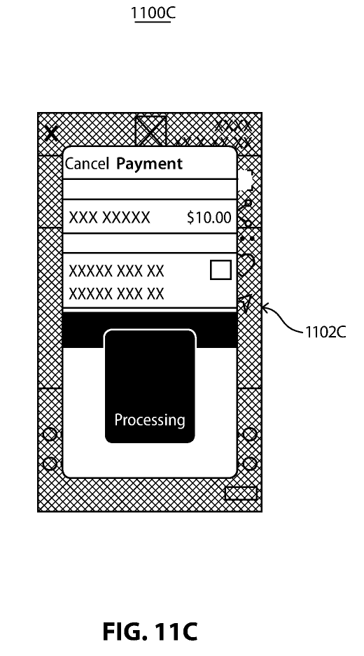

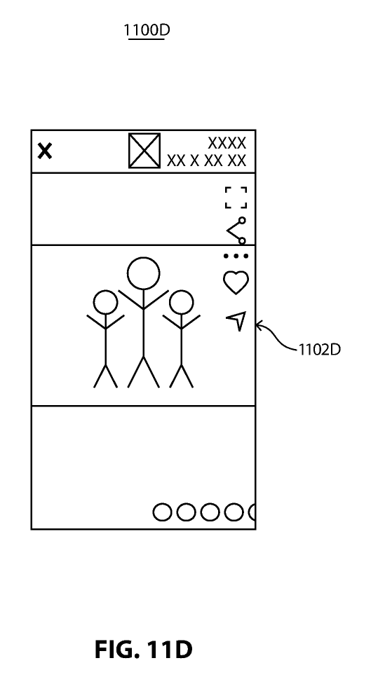

Referring to FIGS. 11A-11D, shown is exemplary screenshots of the method for a user to make flexible payments (i.e., charitable contributions) during a live broadcast. Referring to FIG. 11A, example 1100A shows exemplary screenshot 1102A from the viewpoint of a viewer's device during a broadcast. During a live broadcast, the viewer may select, click, or “tap” an appropriate location or specific icon to make a flexible payment. In the illustrative embodiment, the viewer may select their payment vehicle based on their preferred currency (e.g., PayPal® for USD or WeChat Pay™ for CNY). It is understood that more payment options may be displayed or made available to the viewer. FIG. 11B, example 1100B shows exemplary screenshot 602B of a viewer making a payment via a charge or credit card. The summary page shows the amount to be paid and payment method. The payment method may be previously stored within the app to save the viewer the need to re-insert credit card account information. The viewer may also be enabled to change their preferred or default payment method. The viewer may complete the payment by selecting the option to “Charge Card.” FIG. 11C, diagram 1100C, shows processing of the viewer's payment in screenshot 1102C. FIG. 11D, diagram 1100D, shows the viewer being returned to the live broadcast once the payment is complete in screenshot 1102D. At least one illustrative implementation of a flexible payment during a live broadcast event is during a fundraising event. For example, during a live video broadcast of a politician announcing an election campaign, he or she may accept campaign contributions of any size via the live broadcast platform.

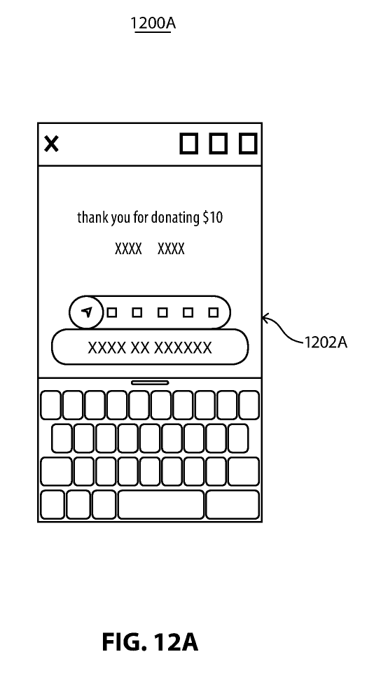

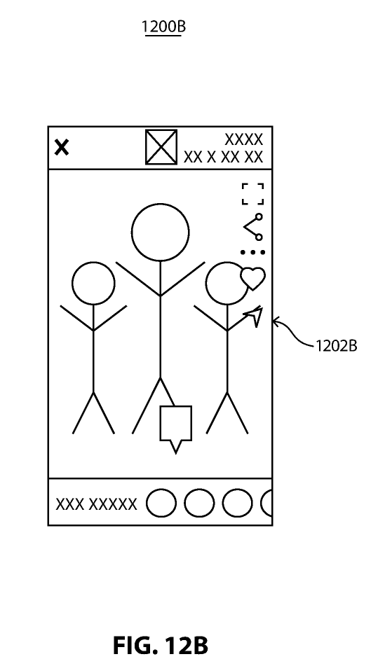

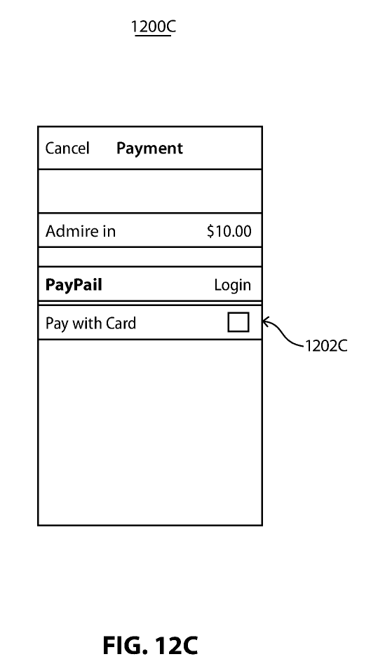

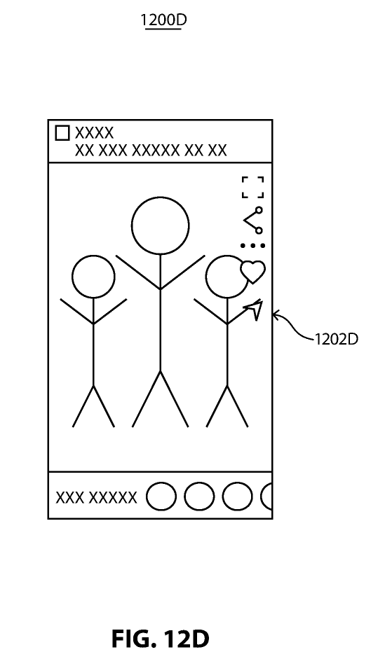

Referring to FIGS. 12A-12D, shown is exemplary screenshots of the method for a user to make fixed payments (i.e., set purchase price) to view an upcoming or ongoing broadcast or during a live broadcast. In a fixed payment scenario, viewers are expected to pay a fixed amount as set by the broadcast host. Referring to FIG. 12A, example 1200A shows exemplary screenshot 1202A from the viewpoint of a broadcast host's device. In the illustrative embodiment, a host may enter a numeric value with a currency symbol in the title field to set the fixed amount. In this non-limiting example, the host has set the amount to $10. It is to be understood that this amount may vary (e.g., $0-$100 and beyond). Based on geographic location, currency type may be updated accordingly. Once the necessary parameters are set, the host may initiate the broadcast by selecting, clicking, or tapping, “Start Video Broadcast.” FIG. 12B, example 1200B shows exemplary screenshot 1202B of a viewer's point of view during the live broadcast. During the broadcast when a payment is made either by the viewer or another viewer of the broadcast, a pop-up icon displaying the amount paid may appear overlaid the broadcast. In the current example, “$10” is shown. The amount shown may vary based on the actual payment or donation made. In another embodiment, a pop-up icon may not be shown when a payment or donation is made based on the privacy settings as set by a host or a viewer. A viewer may initiate a payment or donation by clicking or tapping an appropriate icon, such as an envelope or gift icon, based on icons selected by the host or pre-selected via default by the platform. FIG. 12C, example 1200C shows exemplary screenshot 1202C of a viewer making a payment via a charge or credit card. The summary page shows the amount to be paid and payment method. The payment method may be previously stored within the app to save the viewer of the trouble of reentering credit card account information. The viewer is also enabled to change their preferred or default payment method. After a payment is made, a confirmation may be shown to the broadcast as shown in FIG. 12D. In example 1200D, screenshot 1202D, the broadcast host may receive a drop-down notification indicating payment amount received and who made the payment. Different notifications may be received, such as a pop-up notification or some other type of electronic message notification. In at least one illustrative implementation of a fixed payment during a live broadcast event is during a sales event. For example, a live stream event may be held to prevent fraud of sales of certain items or goods. In at least one example implementation, the authentication of the sales of crabs by crab fisheries from certain lakes or other bodies of water may be secured. By live broadcasting actual catching of crabs by the fishery, viewers may be more inclined to purchase from certain fisheries who utilize the live broadcast platform because they are buying with increased confidence.

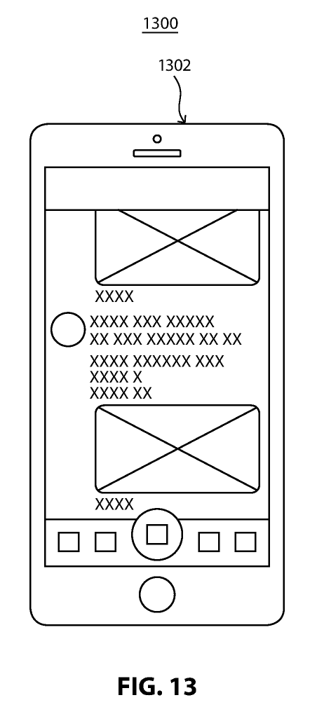

Referring to FIG. 13, example 1300, during a live broadcast on the mobile video messaging platform, a user may enable an AMA (“ask me anything”) broadcast session 1302. During the session, viewing users may pose questions via audio/video/text comments to the broadcasting user. In another embodiment, viewing users may pay a small fee (e.g., 5 cents, $1) or redeem in-app credit before asking a question. Privacy settings may be set by the broadcasting user, such as to hide questions posed by viewers from all viewers, or the like. AMA fees may be set by default or be set by the broadcast host. For example, a lawyer may provide legal advice and set the prepayment price based on their normal or discounted billing rate. In the event an adequate answer is not supplied or the viewer is dissatisfied with the answer provided, payment may be refunded fully or partially via the platform.

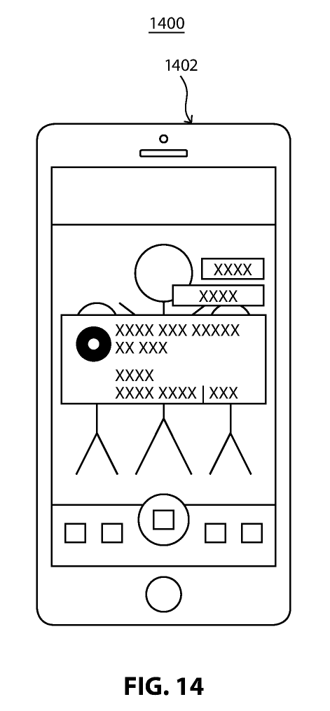

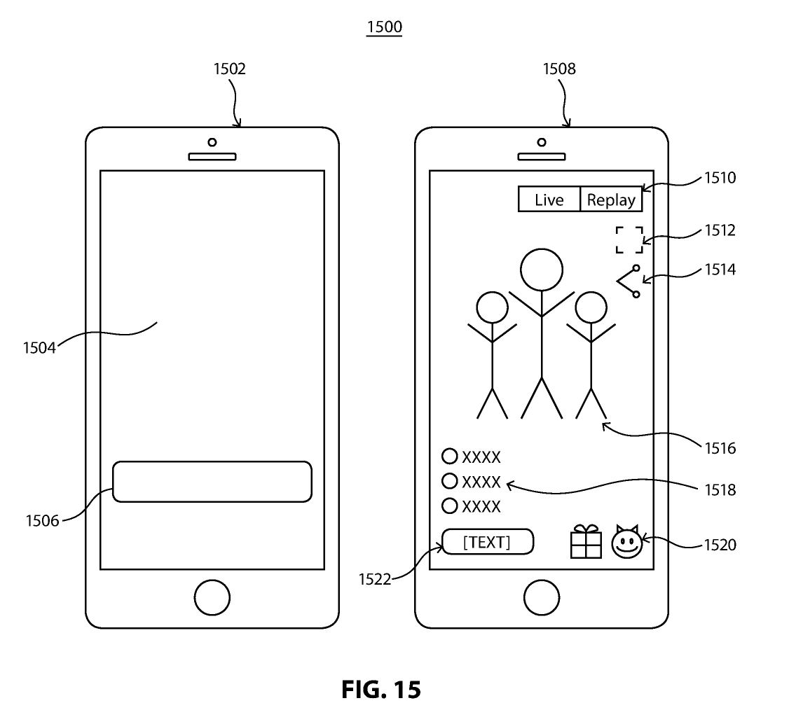

Referring to FIG. 14, example 1400, screenshot 1402 shows an embodiment of a group payment system. In this embodiment, a broadcast host may control a price amount per viewer and a minimum number of paying viewers before a live broadcast is initiated. For example, a broadcast host may define the prepayment price be set at $5 and the minimum number of paying viewers must be 10. Once these thresholds are met, the live broadcast is initiated. In the event that the host thresholds are not met, any prepayments made by prospective viewers may be refunded. At this point, the broadcast host may choose to alter the parameters (i.e. decrease prepayment price, minimum number of viewers, or both).

As is shown in FIG. 5, diagram 1500 is an overview diagram of an exemplary embodiment of the present invention. Device 1502 shows an exemplary screen of upload features of performing a live stream broadcast. Display 1504 shows a current view of the currently selected camera of device 1502. Device 1502 may be configured to comprise more than one camera, such as a front and back camera. A camera-flip icon (not shown) may be displayed to the user to enable a toggle between front/back camera. Button 1506 may be tapped to start a live broadcast, with the option to choose between an audio broadcast, a video broadcast, or both. Different colored buttons may be displayed to the user for different options. Such as a red button for “video” and a translucent or semitransparent button for “audio” only. Upload options may be available to the user, such as the ability to upload the live broadcast to a video-sharing website (e.g., YouTube®) or to upload an album comprising one or more videos to a video-sharing website or elsewhere (e.g., LiveBox®) for later viewing.

Device 1508 shows an exemplary screen of methods of interaction methods of a broadcasting user during a live broadcast. During a broadcast, a user may enter text in box 1522 to be shown to viewing users. By selecting icons 1520, the user may send a gift or an emoticon to other users. Gifts may be of monetary value, such as a gift card to an online merchant or the like. Emoticons may be shown overlaid the video being displayed 1516. Text entered in box 1522 may be shown in 1518. Text comments entered by viewers of the live broadcast may be shown in 1518 as well. Text box 1522 may be enabled to accept audio or video comments. After joining a live broadcast, a viewing user may view an entire chat history. During a live broadcast, the broadcaster may select the “replay” button 1510 to broadcast a replay of determined length (e.g., 5 seconds) or switch back to a “live” view. Screen size may be adjusted by selecting button 1512. Sharing options are made available via selection of button 1514. The broadcaster may be given further options or controls over the live video, such as Rewind/Pause/Fast Forward. In another embodiment, before joining a live broadcast, a viewer may pay an amount of currency set by the broadcaster in order to view a broadcast event (i.e. pay-per-view). Currency may be based on a certain country's currency or an in-app currency, such as tokens or credits.

It is appreciated that exemplary computing system 200 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

I/we claim:

1. A method for monetizing content of an interactive live stream, with at least one computing device, the method comprising:
optimizing placement of at least one advertisement during a media event;
viewing, by at least one user, the media event on a display of a device; and
displaying the at least one advertisement on the device based on the optimized placement;
wherein the optimized placement is based on the media event type.

2. The method of claim 1, wherein the device is a mobile device.

3. A system configured to monetize content of an interactive live stream, the system comprising:
one or more computing memories coupled to at least one hardware processor; and
instructions, stored on the one or more computing memories, when executed by the at least one hardware processor implement:
optimizing placement of at least one advertisement during a media event;
viewing, by at least one user, the media event on a display of a device; and
displaying the at least one advertisement on the device based on the optimized placement;
wherein the optimized placement is based on the media event type.

4. The system of claim 3, wherein the device is a mobile device.

5. A method for monetizing content of an interactive live stream, with at least one computing device, the method comprising:
associating a cost to view with a media event;
broadcasting, by at least one host, the media event;
receiving, from one or more users, the cost to view the media event; and
viewing, by one or more users, the media event, in response to receiving the cost to view.

6. The method of claim 5, wherein the value is set by the broadcast host.

7. The method of claim 5, wherein the cost to view is paid via in-app credit or currency.

8. A method for interactive live streaming, with at least one computing device, the method comprising:
broadcasting, by at least one host, a media event;
viewing, by one or more users, the media event;
receiving, from the one or more users, one or more virtual gifts intended for the host;
displaying, to the host, the one or more virtual gifts.

9. The method of claim 8, wherein the media event is a live event.

10. The method of claim 8, wherein the one or more virtual gifts are redeemable for in-app credit.

11. A method for a virtual payment gateway during interactive live streaming, with at least one computing device, the method comprising:
broadcasting, by at least one host, a media event;
viewing, by one or more users, the media event;
receiving, from the one or more users, at least one payment; and
displaying, on a device associated with the at least one host, indication of the received at least one payment.

12. The method of claim 11, wherein the media event is a live event.

13. The method of claim 11, wherein an amount of the payment is set by the host.

14. The method of claim 11, wherein an amount of the payment is set by the user.

15. The method of claim 11, further comprising:
receiving, along with the at least one payment, a query from the one or more users;
displaying, on a device associated with the inquiring one or more users, a response to the query; and
refunding payment in response to the query response being unsatisfactory.

16. The method of claim 11, wherein payment is split among two or more users.

17. A system configured to conduct interactive live streaming, the system comprising:
one or more computing memories coupled to at least one hardware processor; and
instructions, stored on the one or more computing memories, when executed by the at least one hardware processor implement:
broadcasting, by at least one host, a media event;
viewing, by one or more users, the media event;
receiving, from the one or more users, at least one payment; and
displaying, on a device associated with the at least one host, indication of the received at least one payment.

18. The system of claim 17, wherein the media event is a live event.

19. The system of claim 17, wherein an amount of the payment is set by the host.

20. The system of claim 17, wherein an amount of the payment is set by the user.

21. The system of claim 17, the instructions further implement:
receiving, along with the at least one payment, a query from the one or more users;
displaying, on a device associated with the inquiring one or more users, a response to the query; and
refunding payment in response to the query response being unsatisfactory.

22. The system of claim 11, wherein payment is split among two or more users.

23. A method for interactive live streaming, with at least one computing device, the method comprising:
broadcasting, by at least one host, a media event;
viewing, by one or more users, the media event;
receiving, from the one or more users, one or more comments;
receiving, from the at least one host, one or more responsive comments to the one or more comments; and
displaying the one or more comments and one or more responsive comments overlaid the media event.

24. The method of claim 23, wherein the media event is a live event.

25. The method of claim 23, wherein the one or more comments is at least one of:
text, audio, or video.

26. The method of claim 23, wherein the one or more responsive comments is at least one of:
text, audio, or video.

27. The method of claim 23, wherein the overlaid comments are displayed in real-time.

28. A system configured to conduct interactive live streaming, the system comprising:
one or more computing memories coupled to at least one hardware processor; and
instructions, stored on the one or more computing memories, when executed by the at least one hardware processor implement:
broadcasting, by at least one host, a media event;
viewing, by one or more users, the media event;
receiving, from the one or more users, one or more comments;
receiving, from the at least one host, one or more responsive comments to the one or more comments; and
displaying the one or more comments and one or more responsive comments overlaid the media event.

29. The system of claim 28, wherein the media event is a live event.

30. The system of claim 28, wherein the one or more comments is at least one of:
text, audio, or video.

31. The system of claim 28, wherein the one or more responsive comments is at least one of:
text, audio, or video.

32. The system of claim 28, wherein the overlaid comments are displayed in real-time.
